(19) United States
(12) Patent Application Publication
(10) Pub. No.: US 2006/0104775 A1
(43) Pub. Date: May 18, 2006

(54) Safety belt system for wheelchair lifts

(76) Inventors: Michael E Kasten JR., Winamac, IN (US); Kenneth E Thornburg, Culver, IN (US); Jeffrey J Hermanson, Culver, IN (US); Keith D Heigl, Winamac, IN (US); James R Pierrou, Winamac, IN (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 10/502,067

(22) PCT Filed: Jan. 8, 2003
(86) PCT No.: PCT/US03/00458

§ 371 Date: Sep. 12, 2005

Related U.S. Application Data
(60) Provisional application No. 60/355,175, filed on Feb. 7, 2002.
(60) Provisional application No. 60/361,989, filed on Mar. 5, 2002.

(51) Int. Cl. A61G 3/06

(52) U.S. Cl. 414/546

(57) ABSTRACT

A vehicle access system for moving a passenger between the vehicle and ground. Some embodiments have an electrical system, a motive source coupled to the electrical system, an arm coupled to the motive source, a platform coupled to the arm, and a safety restraint system coupled to the electrical system and the platform. The vehicle access system has at least a vehicle access position and a ground access position, wherein the passenger can safely access the platform at either access position. The platform is unable to move from either access position until the safety restraint system is in place. Once operation of the access system has begun, it can continue to operate and move the passenger to one of the access positions even if the safety restraint system is subsequently removed.

### CROSS-REFERENCE TO RELATED APPLICATIONS

This application claims priority to U.S. provisional Application Ser. Nos. 60/361,989 filed 5 Mar. 2002 and 60/355,175 filed 7 Feb. 2002.

### BACKGROUND OF THE INVENTION

1. Field of the Invention

The present application relates generally to the field of vehicular access systems for handicapped persons, and more particularly to the field of safety devices related to those systems.

2. Description of the Related Art

People who have difficulty walking and people who use wheelchairs often have difficulty moving between different levels, such as getting into and out of vehicles. Consequently, there is a great need for devices that are capable of transporting people into and out of vehicles. Therefore, many different vehicular wheelchair access systems, such as lifts and ramps, have been developed to fulfill this need. These systems can be mounted on vehicles and manipulated between deployed and stowed positions with respect to the vehicle. When these systems are in the deployed position, wheelchair users typically must move their wheelchair along the lift and ramp platforms in order to transfer from the ground to the vehicle and from the vehicle to the ground. During the use of convention vehicle access systems, the passenger or operator can encounter potential dangers, such as falling off of the lift or ramp. Therefore, it is desirable to provide a safety system to assist lift operators and users in operating the access system in a safe manner. The invention of the present application is directed to satisfying these needs, among others.

Many vehicle access systems such as passenger lifts and ramps are known in the art. However, there is a constant desire in the art to make these systems more reliable, cost effective and safe. Many safety features are currently used on several access systems, such as safety belts, barrier plates, and sensors. These restraining devices help prevent wheelchairs from rolling off the access system while in operation or can prevent operation of the access system altogether. However, they can have certain problems that can make them unsafe.

Some vehicle access systems utilize belt buckle with an electronic safety interlock to prevent all movement of the access system until the safety belt is fastened to the buckle. In such devices, the safety interlock is a normally open electric switch located in the buckle. Thus, when the safety belt is unbuckled, the switch is open and the lift is incapable of operation. Once the safety belt is buckled, the switch is closed and the system is capable of operating. However, if the belt is unbuckled in the middle of operation, the system will stop operating. This can create a dangerous situation wherein the passenger is stuck in an elevated position in which the passenger cannot safely access either the vehicle or the ground. Furthermore, the passenger is stuck in this position, unrestrained by the safety belt. Thus, despite other safety features, the passenger may be able to roll off the access system while the system is in a position in which its is not safe to dismount. In such devices, operation of the system will not and cannot continue until the safety belt is buckled once again.

In light of the problems and limitations described above, a need exists for a vehicle access system that is reliable, cost effective, and safe so that either safety restraint systems cannot be removed while in operation or that operation does not automatically cease between access positions even if the safety belt is removed during operation of the system. Each embodiment of the present invention achieves one or more of these results.

### SUMMARY OF THE INVENTION

The vehicle access system according to some embodiments of the present invention has an electrical system, a motive source coupled to the electrical system, an arm coupled to the motive source, a platform coupled to the arm, and a safety restraint system coupled to the electrical system and the platform. The vehicle access system can be mounted to the vehicle and operable to move a passenger between the ground and the vehicle. If the vehicle access system is mounted to the vehicle, it can have three or more main positions and numerous intermediate positions. The main positions can include a stowed position, vehicle access position (loading/unloading position into and out of the vehicle), and a ground access position (loading/unloading position onto and off of the ground). Thus, the passenger can safely access the platform at either access position. Once the passenger is situated and restrained on the platform, the platform can be moved between levels and the passenger can safely dismount the platform at the other access position. The platform, however, is unable to move from either access position until the safety restraint system is in place.

Some embodiments of the present invention utilize a belt and buckle that has a current path through it as part of a safety restraint system. The current path is open when the belt and buckle are unbuckled and closed when they are buckled. The current path through the safety belt, in some embodiments, is coupled to a silicon controlled rectifier diode that is coupled to the electrical system of motive source. The diode has a turned-on and a turned-off state. The motive source can be powered when the diode is turned-on and cannot be powered when the diode has been turned-off. The diode is turned-on and off by a gate coupled to the current path in the buckle. When the current path through the buckle is closed, current flows to the gate of the diode to turn-on the diode and allow current to flow to the motive source. Once the diode is turned-on and so long as current continues to be drawn to the motive source, the diode can remain turned-on regardless of the state of the current path through the buckle. Thus, once operation of the access system has begun, it can continue to operate and move the passenger to one of the safe access positions even if the buckle is subsequently released.

Other embodiments of the present invention can utilize one or more additional safety features alone or in combination with the above mentioned features. For example, some embodiments utilize roll-stops coupled to the platform, while other embodiments utilize a lock on the safety belt to prevent unbuckling during operation to prevent the passenger from rolling off the platform. Yet other embodiments utilize various audible and/or visual signals to alert the operator that the safety belt is unbuckled. Finally, other embodiments can utilize pressure switches coupled to the platform to prevent movement of the platform to the stowed position while the passenger is on the platform.

A better understanding of the principles of the invention will become apparent from the following detailed description of the illustrated embodiments of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show preferred embodiments of the present invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the present invention.

In the drawings, wherein like reference numeral indicate like parts:

FIG. 1 is a perspective view of a vehicular wheelchair access and safety belt system with the platform unfolded and extending from the vehicle in a horizontal entry level position and the safety belt engaged;

FIG. 2 is a perspective view of the system of FIG. 1 with the platform at the ground level position and the safety belt engaged;

FIG. 3 is a perspective view of the system of FIG. 1 with the platform folded to a vertically stowed position and the safety belt engaged;

FIG. 4 is an electrical schematic including for the wheelchair access system including the safety belt system of the present invention; and

FIG. 5 is one embodiment of a wiring diagram for the electrical system of FIG. 4.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated embodiments, and such further applications of the principles of the invention as illustrated herein are contemplated as would normally occur to one skilled in the art to which the invention relates.

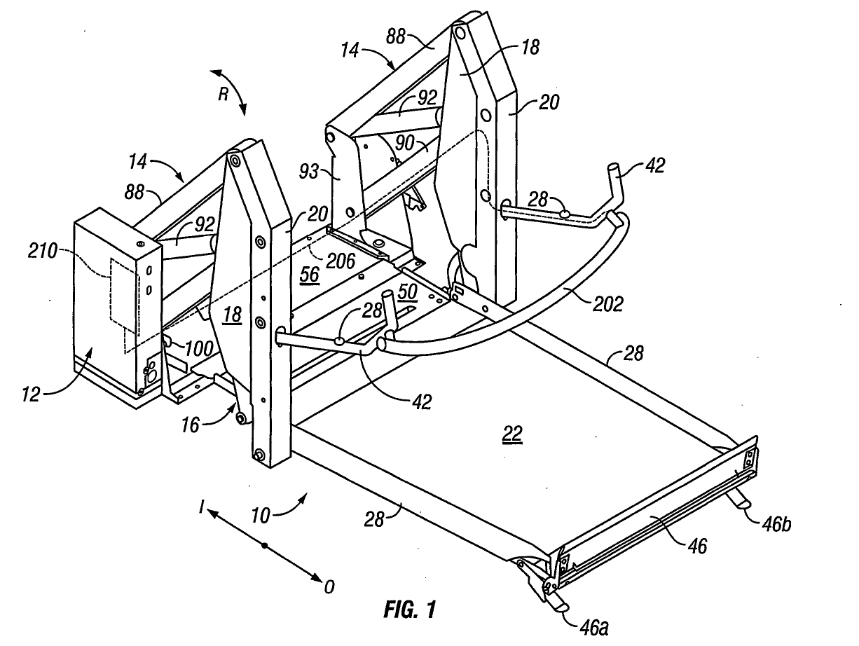

Referring now to FIG. 1 there is illustrated a vehicular access system 10. Although access system 10 is illustrated as a wheelchair lift type system, it is also contemplated that principles discussed herein have application in wheelchair ramp type systems. Access system 10 is mounted in the door of a vehicle (not shown) to provide wheelchair passenger access to and from the vehicle. Access system 10 has a platform 22 movable in the inboard and outboard directions relative to the vehicle, as indicated by arrow I (inboard direction) and arrow 0 (outboard direction.) Examples of wheelchair access systems are provided in U.S. Pat. No. 6,238,169; U.S. Pat. No. 5,806,632; U.S. Pat. No. 5,261,779; U.S. Pat. No. 6,065,924; and U.S. Provisional Application Ser. No. 60/355,175 filed Feb. 7, 2002, each of which is incorporated herein by reference in its entirety. Another example of a wheelchair access system is The Braun Corporation's EV BRAUN ENTERVAN® wheelchair access ramp.

In the illustrated embodiment, access system 10 includes a motive source 12 operatively coupled to paired parallelogram type lifting mechanisms 14. Parallelogram lifting mechanisms 14 include vertical arms 20 to which an inboard end of platform 22 is pivotally coupled. When not in use, it is desirable to stow platform 22 in the vehicle in a vertical orientation adjacent the door of the vehicle to minimize its intrusion into the vehicle. Platform 22 can also be provided with foldable sections for stowage in a reduced height configuration, such as described in the aforementioned Provisional Application No. 60/355,175 filed Feb. 7, 2002.

Access system 10 also includes articulated lever assemblies 16 pivotally connected to the inboard end of platform 22 at one end and to a corresponding one of the vertical arms 20 at their other end. Articulated lever assemblies 16 can include a longer arm pivotally connected to a shorter arm at a common center along with a saddle block for contacting the bottom arm of parallelogram lifting mechanisms 14, such as shown and described in the aforementioned U.S. Pat. No. 6,238,169 and Provisional Application No. 60/355,175 filed Feb. 7, 2002. A safety shield 18 extends from a corresponding one of the vertical arms 20 along each side of articulated lever assemblies 16 to protect against the potential placement of a part of a person or object therebetween before and/or during lift operation.

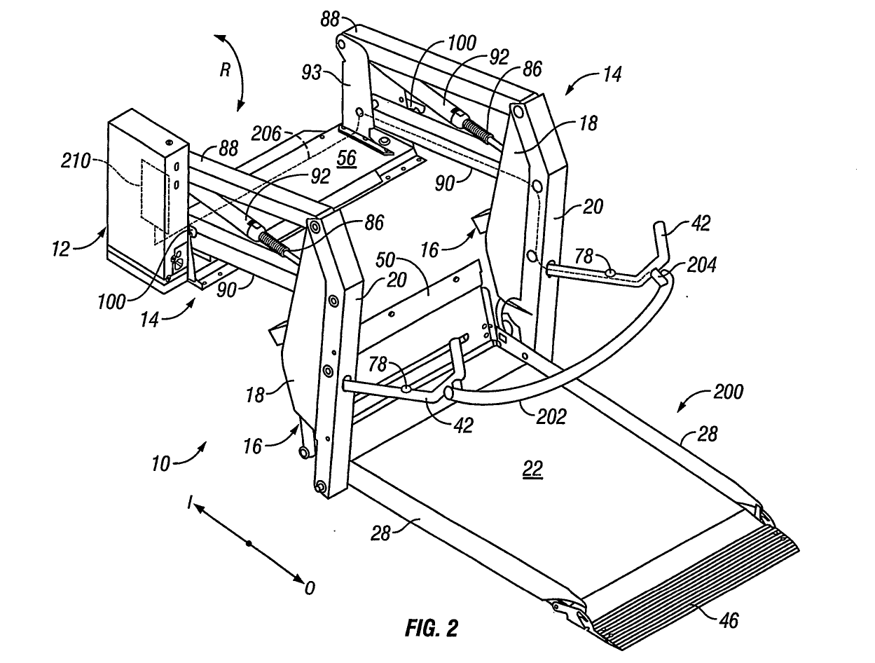

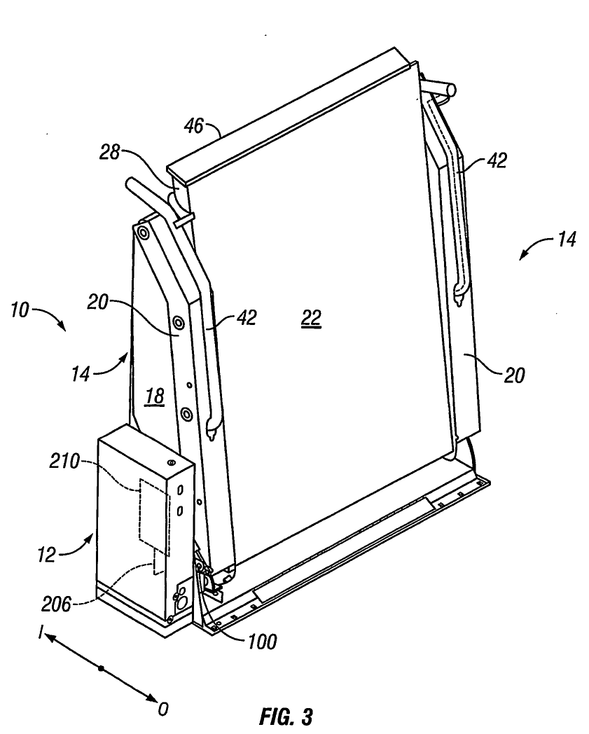

Motive source 12 is operable to swing lifting mechanisms 14 generally along path R to move platform 22 from the vertically stowed position of FIG. 3, to the transfer level position or horizontal entry level position of FIG. 1, to the ground level position of FIG. 2, and back. Motive source 12 can be electrically coupled to the vehicle power source and include hydraulic pumps and/or electrical motors and other components to accomplish the desired movement for lifting mechanisms 14.

Mounting members 93 are secured to a floor plate 56 of the vehicle. Lifting mechanisms 14 are pivotally mounted to a corresponding one of mounting members 93. Each lifting mechanism 14 includes an upper arm 88 and a lower arm 90. Upper arms 88 are each pivotally coupled at their inboard end to a corresponding one of the mounting members 93. Lower arms 90 are also each pivotally coupled at their inboard end to a corresponding one of the mounting members 93 below upper arm 88. Each lifting mechanism 14 also includes a cylinder 92 pivotally coupled at its outboard end to lower arm 90 and also to vertical arm 20. The inboard end of each cylinder 92 is pivotally coupled to the inboard end of the respective upper arm 88 at mounting member 93. A deploy assist mechanism 86 can be provided around each cylinder 92. Further details regarding cylinder 92 and deploy assist mechanism 86 are provided in the aforementioned Provisional Application 60/355,175 filed Feb. 7, 2002.

When platform 22 is in its vertically stowed position, there may be a tendency for platform 22 to drift in the outboard direction due to, for example, a slow loss of hydraulic pressure in cylinder 92. When the platform drifts, it could push against the vehicle door, making opening of the door difficult and also damaging the interior of the vehicle. Thus, there is provided anti-drift mechanism 100. One embodiment of anti-drift mechanism 100 is shown in the aforementioned Provisional Application No. 60/355,175 filed Feb. 7, 2002. Other embodiment anti-drift mechanisms are provided in U.S. patent application Ser. No. 09/702,397 filed on Oct. 31, 2000, which is incorporated herein by reference.

Platform 22 is pivotally coupled at its inboard end to each of the vertical arms 20. Platform 22 has side barriers 28 extending along each side thereof. Platform 22 can be provided with meshed grid-like or solid plate-like transfer surface between the side barriers and between the inboard/outboard ends of platform 22.

Access system 10 also includes a spring-loaded rollstop 46 pivotally connected to the outboard end of platform 22 that is normally spring-biased to a raised safety barrier position as shown in FIG. 1. Rollstop 46 includes feet 46a, 46b (FIG. 1) that contact the ground to move rollstop 46 to lower rollstop 46 to transfer level position extending from the outboard end of platform 22 as shown in FIG. 3.

Access system 10 includes a bridge plate 50 pivotally coupled to the inboard end of platform 22. A pair of actuator assemblies can be provided to couple bridge plate 50 to each of the articulated lever assemblies 16. The actuator assemblies and articulated lever assemblies 16 operate in concert such that contact between articulated lever assemblies 16 and bottom arms 90 of lifting mechanisms 14 variously raise and lower bridge plate 50 between a raised safety barrier position (FIG. 2) and a generally horizontal transfer level position (FIG. 1.) Further details regarding bridge plate 50 are provided in the aforementioned Provisional Application 60/355,175 filed Feb. 7, 2002 and also in U.S. Pat. No. 6,238,169. Other mechanisms for raising and lowering bridge plate 50 are also contemplated.

Access system 10 further includes handrails 42 extending horizontally from vertical arms 20 when platform 22 is deployed in a horizontal position as shown in FIGS. 1 and 2. When folded, as shown in FIG. 3, handrails 42 each extend along a corresponding one of the vertical arms 20. A bumper 78 can be coupled to the upper side of each handrail 42 to eliminate or reduce noise and abrasion when the handrail is positioned against vertical arm 20. Each handrail 42 further includes an outboard end bent to conform to the upper end of vertical arm 20 when folded thereagainst. A grip handle can be placed over the outboard ends of each handrail 42 to facilitate gripping thereof.

A safety belt system 200 is provided with access system 10. System 200 includes a safety belt 202 extending between handrails 42. Safety belt 202 is mounted at one end to one of the handrails 42 and removably engaged to a buckle 204, which is mounted on the other handrail 42. It is contemplated that safety belt 202 can include a strap and end member like that of an automobile seat belt for engagement with buckle 204. Other configurations are also contemplated, so long as safety belt 202 is removably engageable with buckle 204. Safety belt 202 can be non-retractable, although a retractable belt is also contemplated. Buckle 204 can have any configuration suitable for engagement with the end member of safety belt 202. Buckle 204 includes a current path therein that is coupled with the electrical system 210 of motive source 12 by, for example, electrical wiring 206. It is contemplated the current path in buckle 204 is normally open, and is closeable upon engagement of the end member of safety belt 202 with buckle 204. Closing the current path in buckle 204 enables electrical system 210 to provide power to move platform 22 with motive source 12.

Platform 22 has three main positions including the vertically stowed position (FIG. 3), the horizontal transfer level position (FIG. 1), and the ground level position (FIG. 2.) Access system 10 includes sensors providing signals to electrical system 210 indicating when the platform is at one of the three main positions. The platform position signals from platform sensors for the stowed position and the floor level position may be used to stop platform movement when the desired position is reached.

When the current path in buckle 204 is closed by engaging the end member of belt 202 to buckle 204, electrical system 210 can provide power to motive source 12 to move platform 22 between the three main positions with lifting mechanisms 14 based on operator signal input indicating the desired platform movement. When safety belt 202 is not coupled with buckle 204, the current path of electrical system 210 in buckle 204 is open and platform movement cannot be initiated by operator input signals.

The safety belt system of the present invention enhances operator control of the lift during platform movement. If the current path in buckle 204 is closed with the end member of safety belt 202, and platform movement has been initiated by operator signal inputs, and the current path in buckle 204 is thereafter opened during platform movement by disengaging the end member of belt 202, the current path in electrical system 210 is maintained for platform movement to one of the three main positions. However, platform movement can be stopped at any position intermediate the three main positions by the operator. Thus, the operator maintains control over lift operation even if safety belt 202 is unbuckled.

When safety belt 202 is unbuckled, and when platform is at one of the three main positions or has been stopped by the operator at an intermediate position, the current path of electrical system 210 is open to prevent platform movement. Platform movement can continue when the end member of belt 202 is engaged to buckle 204 to close the current path in buckle 204.

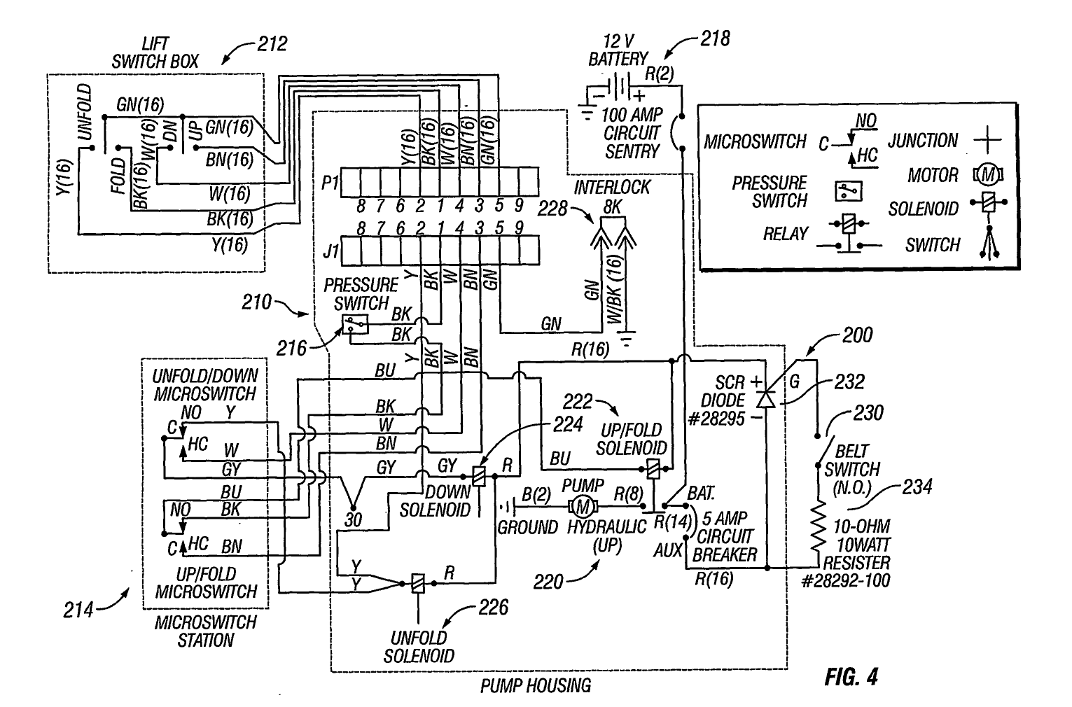

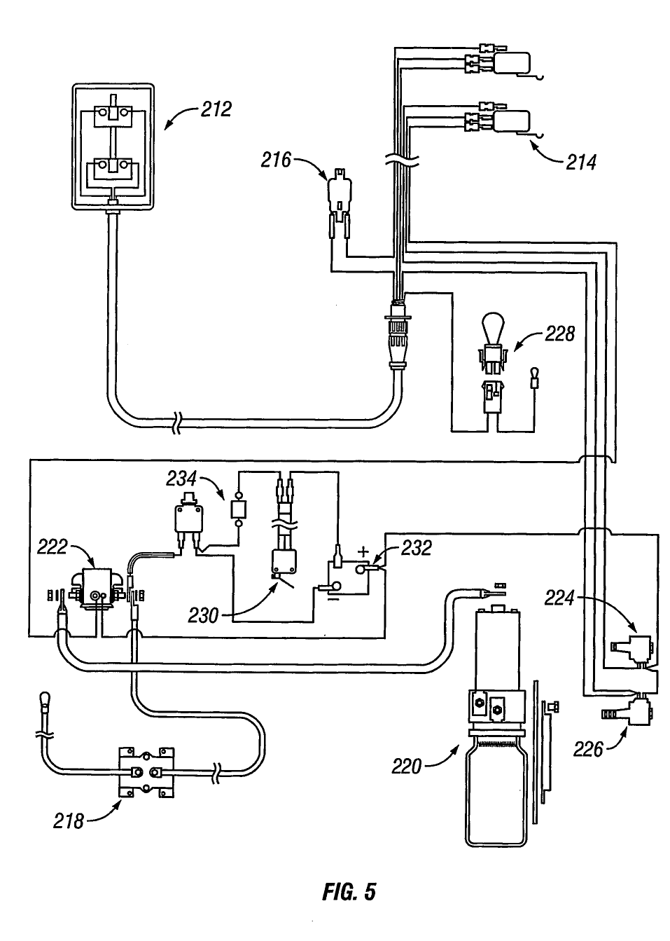

In FIG. 4, there is shown an electrical schematic of one embodiment of electrical system 210 for providing power to move platform 22. In FIG. 5 there is shown one embodiment of a wiring diagram for electrical system 210 of FIG. 4. Electrical system 210 is electrically coupled to safety belt system 200. In the illustrated embodiment, electrical system 210 includes an operator input device 212 electrically coupled to a microswitch station 214. It is contemplated that input device 212 could also employ infrared or radio signals to communicate input signals from the operator. It is further contemplated that a programmable controller could be provided in lieu of or in addition to microswitches 214. Electrical system 210 further includes a power source 218. It is contemplated that power source 218 can be the vehicle's main battery or backup battery, or a stand-alone battery dedicated to electrical system 210. Input device 212, microswitches 214 and power source 218 are electrically coupled to a pump housing 215.

Pump housing 215 includes a drive means 220, an up/fold controller 222, a down controller 224 and an unfold controller 226. In the illustrated embodiment, controller 222 is a controller which controls operation of drive means 220, and controllers 224 and 226 are solenoids that control operation of valves of a hydraulic system coupled between drive means 220 and cylinder 92. Drive means 220 includes a hydraulic pump and motor to supply hydraulic pressure to cylinders 92 to raise platform 22 from the ‘ground level position to the entry level position, and also to vertically fold platform 22 from the entry level position. An interlock 228 is provided to allow coupling of additional sensors and the like to electrical system 210. For example, a sensor can be mounted on the vehicle door and coupled to electrical system 210 via interlock 228. Control of the operation of platform 22 can be based on satisfaction of an external condition determined by the sensor, such as whether the vehicle door is completely open.

Safety belt system 200 is electrically coupled between power source 218 and pump housing 215 to control the operation of drive means 220. In the illustrated embodiment, safety belt system 200 includes a safety belt switch 230 in buckle 204, a current flow control device 232 in the form of an SCR diode, and a resistor 234. Current flow control device 232 includes gate G that prevents current flow therethrough when the current path in buckle 204 is open. When the current path in buckle 204 is open, current flow control device 232 disables electrical system 210 by blocking the current path to operate drive means 220 and controllers 222, 224, and 226 with operator input signals from input device 212.

When the current path in buckle 204 is closed, current from power source 218 flows through resistor 234 and switch 230 to energize and open gate G of current flow control device 232. With gate G open, current can flow through current flow restrictor 232, and power is provided from power source 218 to operate controllers 222, 224 and 226 based on operator input signals from signal input device 212. Such signals initiate folding or unfolding of platform 22 between the vertically stowed and horizontal entry level positions, and the moving platform 22 up or down between the horizontal entry level and ground level positions. If the current path in buckle 204 is opened by unbuckling belt 202 from buckle 204, gate G remains opened until one of the platform positions is sensed at either stowed or floor level position or until platform operation is stopped by the operator. However, once one of the main positions of platform 22 is sensed or platform movement is stopped by the operator through signal input device 212, power cannot be supplied to drive means 220 and controllers 222, 224, 226 until the circuit in buckle 204 is closed by engaging belt 202 to buckle 204.

In the illustrated embodiment, signal input device 212 includes an unfold input and a fold input selectable by the operator to provide signals indicative of the desired platform movement from the vertically stowed position to the horizontal transfer level position and back, respectively. Signal input device 212 also includes a down input and an up input selectable by the operator to provide signals indicative of the desired platform movement from the horizontal entry level position and the ground level position and back, respectively.

It is contemplated that microswitch station 214 includes unfold/down microswitches and up/fold microswitches coupled to controllers 222, 224, 226 to control platform 22 movement in accordance with the commands received from signal input device 212 as selected by the operator. In the illustrated embodiment, the up/fold microswitch signals the up/fold controller 222 to start or stop drive means 220. The unfold/down microswitch signals down controller 224 to open and close a first valve in the hydraulic system, and also signals unfold controller 226 to open and close a second valve in the hydraulic system.

In operation, when the up input is selected by the operator and safety belt 202 is engaged to buckle 204, controller 222 starts drive means 220 wherein the hydraulic pump provides pressurized hydraulic fluid to cylinder 92 to move platform 22 from the ground level position to the horizontal entry level position. Belt 202 can be disengaged from buckle 204 during this movement without affecting platform movement to the entry level position. When the platform reaches the entry level position sensors provide a signal to direct controller 222 to stop drive means 220.

When the fold input is selected by the operator and safety belt 202 is engaged to buckle 204, controller 222 starts drive means 220 to provide pressurized hydraulic fluid to cylinder 92 to move platform 22 from the horizontal entry level position to the vertically stowed position. Belt 202 can be disengaged from buckle 204 during this movement without affecting platform movement to the vertically stowed position. When the platform reaches the vertically stowed position sensors provide a signal to direct controller 222 to stop operation of drive means 220.

When platform 22 is in the vertically folded position and safety belt 202 is engaged to buckle 204, operator selection of the unfold input signals down controller 224 to open the first valve in the hydraulic system and also signals unfold controller 226 to open the second valve in the hydraulic system. Belt 202 can thereafter be disengaged from buckle 204 without affecting platform movement to the entry level position. Unfolding of platform 22 is controlled by directing the hydraulic fluid through the second valve, which includes or is in fluid communication with a restricted orifice. The restricted orifice causes the pressure to be relieved more slowly than would result if only the first valve were opened, thus' slowing movement of platform 22 from the vertically stowed position to the horizontal entry level position. When the platform reaches the entry level position sensors provide a signal to direct controllers 224, 226 to shut the first valve and the second valve.

When platform 22 is at the horizontal entry level position and safety belt 202 is engaged to buckle 204, a down input from the operator signals down controller 224 to open the first valve to relieve hydraulic pressure from cylinder 92 to allow platform movement from the horizontal entry level position to the ground level position. Belt 202 can be disengaged from buckle 204 during this movement without affecting platform movement to the ground level position. There is no ground level sensor. See note on page 8.

In one alternate embodiment, electrical system 210 does not include an unfold controller 226 coupled to a restricted orifice, but rather only a down controller 224 to open the first valve to relieve pressure from cylinder 92. Hydraulic pressure is relieved through this first valve for platform movement both from the vertically stowed position to the entry level position, and from the entry level position to the ground level position. In such an alternate embodiment, the restricted orifice is not needed since controller 224 and the first valve coupled thereto allow platform 22 to unfold from the vertically stowed position at a rate within a desired range. Factors that influence whether the unfold rate of movement of platform 22 can be maintained in the desired range using only controller 224 and the first valve include the size of platform, the rates at which the desired range is established, and whether the first valve can be modulated for varying flow rates therethrough. Another factor is whether platform 22 is folded to a reduced height configuration when vertically stowed such as described in the aforementioned Provisional Application 60/355,175 filed Feb. 7, 2002. If platform 22 is provided as described therein, then only a single down controller 224 is needed since the reduced height, folded platform will unfold from the vertical position at a slower rate than if the platform were not folded to a reduced height configuration.

Referring back to the illustrated embodiment, it is contemplated that the microswitches or other controller means can be configured so that with platform 22 in the entry level position signals from the unfold input and the up inputs of signal input device 212 are ignored or disabled. In the ground level position, signals from the fold input, unfold input and down input of signal input device 212 are ignored or disabled. In the vertically stowed position, signals from the fold input, down input and up input of signal input device 212 are ignored or disabled.

From the horizontal entry level position, the operator can then either fold the platform to the vertically stowed position or again move the platform to the ground level position as discussed above. When platform 22 is at the horizontal entry level position, a wheelchair passenger can be positioned on platform 22 from the vehicle. Pressure switch 216 thereafter prevents movement of platform 22 from the horizontal entry level position to the vertically stowed position if the fold input is selected. Selection of the down input moves platform 22 from the horizontal entry level position to the ground level position where the wheelchair passenger exits the lift. Another wheelchair passenger may then board the lift, and platform 22 raised from the ground level position to the entry level position by selecting the up input. The wheelchair passenger on platform 22 can then enter the vehicle. Again, pressure switch 216 prevents platform 22 from being moved from the horizontal entry level position to the vertically stowed position until the wheelchair is off of platform 22. When platform 22 is clear of passengers, the fold input can be selected to move platform 22 to the vertically stowed position. Further examples and discussion regarding pressure switch 216 are provided in U.S. patent application Ser. No. 09/430,436 which is incorporated herein by reference in its entirety.

It is also contemplated that the fold and unfold inputs of signal input device can be integrated into a single input, and that the up and down inputs can be integrated into a single input. The single unfold/fold input would unfold the platform if the platform is determined to be in a folded condition, and fold the platform if the platform is determined to be at horizontal transfer level position. Activation of the single up/down input will lower the platform if the platform is determined to be in a horizontal entry level position, and raise the platform if the platform is determined to be at the ground level position. Platform movement can be stopped and reversed by providing a second input after initial movement has been initiated.

It is contemplated that the fold and unfold inputs and up and down inputs on signal input device 212 can be momentary contact switches that require the operator to hold the switch closed for platform movement to a desired position. If the operator releases the switch, then platform movement stops immediately. When the switch is again activated, platform operation continues toward the desired position so long as the operator maintains the switch closed.

It is also contemplated that the fold and unfold inputs and the up and down inputs on the input control device can be continuous contact switches that require the operator to activate the switch for platform movement. If the operator releases the switch, platform movement continues to the appropriate vertically stowed, horizontal entry level or ground level position unless the switch is reactivated or a stop signal is received.

A further embodiment of safety belt system 200 contemplates providing an alarm to signal disengagement of safety belt 202 from buckle 204. The alarm could be an audio signal and/or visual signal to the operator. The alarm would notify the operator that safety belt 202 is unbuckled so that the operator can take an appropriate action. For example, upon indication that safety belt 202 is unbuckled, the operator may want to immediately stop platform movement by providing the appropriate signal through signal input device 212. For embodiments in which input device includes momentary contact switches, the operator could simply release the switch to stop platform movement intermediate one of the main positions. In another example, the operator may desire that platform movement continue to one of the main positions. For embodiments in which input device includes momentary contact switches, the operator could simply maintain the switch in the closed position to continue platform movement to the next main position.

A further embodiment of safety belt system 200 includes a safety belt locling system that prevents unbuckling of safety belt 202 from buckle 204 during platform movement. Such an interlock device would receive a signal from electrical system 210 that platform movement has been initiated, and would thereupon lock safety belt 202 to buckle 204. Once platform movement has stopped by reaching one of the main positions, or has been stopped by the operator, safety belt 202 would automatically unlock from buckle 204, and could thereafter be unbuckled.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. An assembly capable of moving a passenger from a first surface to an adjacent second surface wherein the surfaces are located at different vertical levels, the assembly comprising an electrical system;
a platform moveable to transport the passenger between the surfaces, the platform having an inboard end, an outboard end, and two opposing sides, the inboard end closer to the first surface than the outboard end;
an arm coupled to the platform and to the first surface, the arm moveable through a first path to transfer the platform between the surfaces;
a passenger support located above the platform;
a safety restraint system coupled to the passenger support, the safety restraint system comprising:
a belt coupled to the passenger support in a first location;
a buckle releasably engagable with the belt and coupled to the passenger support in a second location, the buckle having a current path coupled to the electrical system of the motive source, the current path having an open state and a closed state defined in part upon the releasable engagement between the buckle and the belt, the current path closed upon engagement between the buckle and the belt; and
a motive source coupled to the electrical system and operable to move the arm through the first path, the motive source incapable of initiating movement of the arm when the current path is open and capable of initiating movement when the current path is closed, the motive source capable of continuing movement of the arm regardless of the current path state once movement is initiated.

2. The assembly as recited in claim 1, wherein the platform further comprises side barriers located near the opposing sides and a roll stop located near the outboard end.

3. The assembly as recited in claim 2, wherein the roll stop is biased between two positions, the first position allowing items to be rolled on or off the outboard end and the second position preventing item from rolling on or off the outboard end.

4. The assembly as recited in claim 1, further comprising a bridge plate pivotally coupled to the inboard end of the platform and positionable to bridge a gap between the platform and the first surface.

5. The assembly as recited in claim 1, further comprising an articulated lever assembly coupled to the platform, the lever assembly capable of moving the platform from a substantially horizontal position to a substantially vertical position.

6. The assembly as recited in claim 5, further comprising a pressure switch coupled to the platform, the pressure switch prevents the platform from moving to the vertical position when the passenger is on the platform.

7. The assembly as recited in claim 1, wherein the motive source comprises a hydraulic pump in fluid communication with a hydraulic cylinder coupled to the arm.

8. The assembly as recited in claim 1, wherein the safety restraint system further comprises a current flow control device coupled to the current path, the current flow control device comprising an silicon controlled rectifier diode that controls current flow to the motive source.

9. The assembly as recited in claim 1, wherein the safety restraint system further comprises a lock coupled to the buckle and the belt, the lock preventing disengagement between the belt and the buckle during movement of the platform.

10. The assembly as recited in claim 1, further comprising an alarm coupled to the safety restraint system, the alarm operable to indicate disengagement between the buckle and the belt.

11. A safety restraint system usable with an electrically operated lift system, the safety restraint system comprising:
a belt; and
a buckle releasably engagable with the belt and having a current path coupled to the electrically operated lift system, the current path having an open state and a closed state defined in part upon the releasable engagement between the buckle and the belt, the current path closed upon engagement between the buckle and the belt, the electrically operated lift system incapable of initiating movement when the current path is open and capable of initiating movement when the current path is closed, the electrically operated lift system capable of continuing movement regardless of the current path state once movement is initiated.

12. The assembly as recited in claim 11, wherein the safety restraint system further comprises a current flow control device coupled to the current path, the current flow control device comprising a silicon controlled rectifier diode that controls current flow to the electrically operated lift system.

13. The assembly as recited in claim 11, wherein the safety restraint system further comprises a lock coupled to the buckle and the belt, the lock preventing disengagement between the belt and the buckle during movement of the platform.

14. The assembly as recited in claim 11, further comprising an alarm coupled to the safety restraint system, the alarm operable to indicate disengagement between the buckle and the belt.

15. A lift mountable onto a vehicle for transporting a passenger between the floor of the vehicle and the street, the lift comprising:
a platform coupled to the vehicle and moveable between the floor and the street, the platform having an inboard and an outboard end, the inboard end closer to the first surface than the outboard end;
a linkage defined in part by two arms pivotally coupled between the platform and the floor, the arms of the linkage moveable through a range of motion;
an electrically operated drive system coupled to the linkage and actuateable to move the linkage through the range of motion;
a pair of handrails coupled to the platform;
a buckle coupled to one of the pair of handrails;
a belt coupled to the other of the pair of handrails and removeably engaged with the buckle, the buckle and the belt having an engaged state and a disengaged state; and
a user manipulable switch coupled to the electrically operated drive system, the switch having an open condition and a closed condition, the drive system incapable of initiating actuation when the switch is in the closed condition and the buckle and belt are in the disengaged state, the drive system capable of initiating actuation when the switch is in the closed condition and the buckle and belt are in the engaged state, and the drive system capable of continuing actuation once begun when the switch is in the closed condition and the buckle and belt are in the disengaged state.

16. The assembly as recited in claim 15, wherein the platform further comprises a roll stop located near the outboard end, the roll stop is biased between two positions, the first position allowing items to be rolled on or off the outboard end and the second position preventing items from rolling on or off the outboard end.

17. The assembly as recited in claim 15, further comprising a bridge plate pivotally coupled to the inboard end of the platform and positionable to bridge a gap between the platform and the vehicle floor.

18. The assembly as recited in claim 15, further comprising an articulated lever assembly coupled to the platform, the lever assembly capable of moving the platform from a substantially horizontal position to a substantially vertical position.

19. The assembly as recited in claim 18, further comprising a pressure switch coupled to the platform, the pressure switch prevents the platform from moving to the vertical position when the passenger is on the platform.

20. The assembly as recited in claim 15, wherein the drive system comprises a hydraulic pump in fluid communication with a hydraulic cylinder coupled to the linkage.

21. The assembly as recited in claim 15, further comprising a current flow control device coupled to the electrically operated drive system, the current flow control device comprising an silicon controlled rectifier diode that controls current flow to the drive system.

22. The assembly as recited in claim 15, further comprising a lock coupled to the buckle and the belt, the lock preventing disengagement between the belt and the buckle during movement of the platform.

23. The assembly as recited in claim 15, further comprising an alarm coupled to the buckle, the alarm operable to indicate disengagement between the buckle and the belt.

24. A method of moving a passenger between the ground and a vehicle, the method comprising:
moving the passenger onto a platform coupled to the vehicle;
buckling a seatbelt about the passenger;
actuating a switch to operate an electrical motive source coupled to the platform, the motive source inoperable to move the platform from an at rest position without the seatbelt fastened and operable to move the platform from an at rest position with the seatbelt fastened, the motive source capable of being continually operable as the platform is moving regardless of the seatbelt being fastened;
powering the motive source;
lifting the platform and the passenger between the ground and the vehicle; and
moving the passenger off the platform.
